(19) United States
(12) Patent Application Publication
(10) Pub. No.: US 2003/0075494 A1
(43) Pub. Date: Apr. 24, 2003

(54) Apparatus for providing electrical power, fuel gas, and pure water to a building

(76) Inventor: Randall J. Miranda, Tarpon Springs, FL (US)

Correspondence Address: Stephan A. Pendorf, Pendorf & Cutliff, P.O. Box 20445, Tampa, FL, 33622-0445, US

(21) Appl. No.: 10/045,195

(22) Filed: Oct. 22, 2001

(51) Int. Cl. C02F 9/12

(52) U.S. Cl. 210/243; 210/241; 210/259; 210/257.1; 210/541

(57) ABSTRACT

Method and apparatus for providing a building with the entire requirements of AC/DC electrical power, fuel gas, and pure water in a single integrated unit. The method is based on the convertion of graphite from solid state to a gaseous state using an electrolysis process underwater.

### BACKGROUND OF THE INVENTION

1. Field of the Invention

The present invention concerns an apparatus for providing all of the requirements for a building regarding AC/DC electrical power, fuel gas, and pure water. More specifically, the invention concerns an apparatus for providing household or similar with electrical power, fuel gas, and pure water that is in a single integrated unit.

2. Discussion of the Related Art

As time passes, energy consumption has continued to increase throughout the world as a result of the population explosion, accelerated industrialization, economic growth, and social development.

Conventionally, large generators in electric power plants have produced electrical energy requirements for residential and commercial use. These generators are commonly driven by fossil fuel (oil, natural gas, and coal) and nuclear energy sources.

Power plants utilizing nuclear fuels produce radioactive wastes, and the storage of these wastes is highly controversial.

When the combustion fuel is coal, numerous problems are presented. One of these is that the combustion fuel gases of coal include certain particularly undesirable materials therein for release to the atmosphere or which can damage downstream equipment. These include: particulates; oxidized sulfur compounds such as sulfur dioxide; nitrous oxides; and CO₂. In the United States, there are already controls or limits on the amounts of sulfur dioxide that can be expelled with off gases from coal combustion processes.

Another problem presented by the distribution and delivery of electrical power from power plants is that hydrocarbon fired and nuclear fussion fired boilers, as through use of pressurized steam by operating steam turbines, which in turn drive electrical generators, utilizing the most modern techniques, provides at best a thermodynamic efficiency of 32-39 percent. Much of the remaining energy (61-68 percent) is, of course, irretrievably lost as waste heat and wastefully warms the outdoor air above power plant smokestacks, and warms rivers and streams which are partially diverted by many electric utilities for the purpose of conveniently carrying away the waste heat.

Another problem presented by the power plants is that the electrical power must be transmitted from the power plant over long distances utilizing extremely expensive, high voltage technology.

It would be much more efficient to convert such combustion to electrical energy at the locality or installation wherein electrical energy is to be utilized and to locally recover the waste heat of such combustion and conversion for a useful purpose, rather than permitting the by-product heat otherwise irretrievably to be lost as in the commercial generation of electrical power.

Further, considered from the standpoint of the installation in the individual home or from the standpoint of a total community or power service region, the electrical power systems from the power plants have been characterized by problems or shortcomings in one or another of the areas of fuel economy, peak power loads, general efficiency, and maximum flexibility or adaptability to the individual energy needs of a given building and to cyclical, seasonal, or other changes in such needs.

The use of small portable electric generators for supplying electricity to a building in case of a power failure has been known for many years.

For example, U.S. Pat. No. 3,691,393 to Papachristous entitled “Automatic Starter for Internal Combustion Machine” describes an engine driven generating system including an automatic starter for starting the engine in response to loss of power from a main supply, i.e., conventional utility service. Thus, the system disclosed therein is one of a standby nature to be utilized only in the event of interruption of the normal supply of electrical energy to a load. Such patent is merely representative of many teachings of the prior art of standby generator systems, which are configured or adapted for providing standby electrical power in the event of failure of the normal utility power service.

The degree of sophistication of energy supplying systems for totally providing electrical power requirements of a residential or other building in lieu of that otherwise provided by an AC utility service is evidenced by U.S. Pat. No. 3,678,284 to Peters entitled “Energy Supply Apparatus and Method for a Building.” The reference describes a system for supplying electrical and thermal energy to a building. This system is arranged in association with electrical power from a conventional external source whereby, under certain conditions, an electrical generator of the system is adapted to be utilized to supply the entire AC power requirements of certain loads in the building.

Furthermore, electrical generating apparatus of the prior art typically has not been capable of providing alternating current in precise phase synchronism with the electric power supplied by utility services except where engine speed is extraordinarily tightly regulated. Yet, even in the case of operation at precisely regulated speeds, engine and generator arrangements of the prior art have not been capable of operation in such a way that best fuel efficiency can be achieved over a highly variable load demand.

None of these various approaches of the prior art disclose a system that provides all the AC/DC energy requirements of a building, and at the same time, fills the building demands of pure water and fuel gas.

The present inventor felt a need for a simplified, economical, reliable, non-air-polluting, and easy-to-use apparatus for producing electrical power, fuel gas, and pure water to a building. More specifically, an apparatus for providing a household or similar with electrical power, fuel gas, and pure water that is in a single integrated unit.

### SUMMARY OF THE INVENTION

Therefore, the main object of the present invention is to provide an apparatus for providing a building with all of its requirements regarding electrical power, fuel gas, and pure water that are in a single integrated unit.

It is yet another object of this invention to provide an apparatus which does not discharge polluting effluents into the atmosphere.

It is yet another object of the invention to provide a new energy converting apparatus for generating AC/DC electrical energy for use for domestic or commercial purposes.

It is yet another object of the invention to provide such an apparatus which is of a self-contained, relatively compact, pre-packaged character.

It is yet another object of the invention to provide such an apparatus that provides AC/DC electrical energy, fuel gas, and pure water in an extremely efficient manner.

It is yet another object of the invention to provide an improved power generating fuel gasification cycle that has low space and low cost requirements.

It is yet another object of this invention to provide an apparatus for the fuel gasification of graphite using the principle of electrolysis to generate enough power to furnish the power requirements of the electrolysis process and also for making available AC/DC electric power, pure water and fuel gas to a building.

It is yet another object of the instant invention to provide an apparatus for the fuel gasification of carbon using the principle of electrolysis, which results in a dependable system, that is easily maintained.

In view of the foregoing disadvantages inherent in the known apparatus for providing electricity to a building, the present inventor discovered an apparatus for providing a building with the entire requirements of a building of AC/DC electrical power, fuel gas, and pure water in a single integrated unit. A method in which the use of subsequent cleaning and conversion steps to either separate or filter out the undesired fuel gases, or high consumption of electrical energy, will not be necessary.

Broadly, these and other objects of the present invention have been accomplished By an apparatus comprising in combination:

an electrolysis tank adapted for converting graphite into a fuel gas by an electrolysis process under water, wherein the electrolysis process further produces a steam;

a water distiller adapted to receive the steam produced by the electrolysis process and generate pure water;

a storage tank adapted to receive a first portion of the fuel gas and dispense the fuel gas according to the the building requirements; and

a gas burning generator adapted to receive a second portion of the fuel gas and generate AC/DC electrical power.

The invention was based on the conversion of graphite from solid state to gaseous state and further producing electricity, pure water, and fuel gas to meet the requirements of a building. The gasification of the graphite was achieved by using electrolysis. A direct voltage potential was applied underwater to the graphite inside an electrolysis tank. The spark produced during the electrolysis generates enough heat to boil the water inside the electrolysis tank and also dissociates the water into its chemical elements, hydrogen & oxygen.

Although the exact mechanism by which the fuel gas is produced is not understood, it is believed that the oxygen & hydrogen gases rise to the top of the tank, and merge with the carbon gas that was generated by the graphite; the combination of these three gases will generate the desired fuel gas.

A portion of the fuel gas generated by the electrolysis process was pumped via an air compressor into a holding tank that was used to feed a gas-burning generator. The generator produced the electrical power needed to maintain the system going all the time, as well as to supply all the electrical power to a residential or commercial building.

At the same time, the process generated pure water. The boiling of the water generated a steam that was collected in a separate unit within the apparatus and was processed through a distiller in order to generate pure water.

Another portion of the fuel gas generated by the electrolysis process was pumped via an air compressor into the building main storage tank to be used for the heating system, stoves and ovens, as well as for the water heater and grill apparatus.

The present invention includes applying science to economic advantage, and at the same time producing extra money to the owner of the system. For example, Florida Statutes: 366.051 established that “electricity produced by cogeneration and small power production is of benefit to the public when included as part of the total energy supply of the entire grid of the state or consumed by a cogenerator or small power producer. The electric utility in whose service area a cogenerator or small power producer is located shall buy, in accordance with aplicable law, all electricity offered for sale by such co-generator or small power producer; or the co-generator or small power producer may sell such electricity to any other electric utility in the state.”

The AC/DC power is normally provided to a household or similar relatively small load by a conventional AC utility service, i.e., commercial power source, by a preexisting power distribution network such as the wiring which normally connects the utility to household loads, such as for lighting, heating, operation of appliances, etc. The present invention is, therefore, not primarily concerned with providing auxiliary AC power in the event of failure of a utility service and is not fundamentally intended to serve as a so-called standby power source which typifies the purpose of prior art household electrical power generating systems.

The present invention relates to an apparatus, and in particular, relates to a power generator which consumes no fossil fuels, does not pollute the environment, and which makes it possible to obtain large amounts of power at low cost.

The invention may be summarized as an on-site energy supply apparatus suitable for all types of buildings and enclosures requiring fuel gas, pure water, and electricity.

This invention employs a novel approach so as to result in a greater product yield when sanitary district water is purified; lower costs; increased efficiency; and independent control of the amount of electrical power and pure water produced.

Before explaining in detail the present invention, it is to be understood that the invention is not limited to the details of construction and the arrangement of the parts illustrated on the accompanying drawings since the invention is capable of other embodiments. Also, it is to be understood that the phraseology or terminology herein is for the purpose of description and not limitation.

The foregoing has outlined rather broadly the more pertinent and important features of the present invention in order that the detailed description of the invention that follows may be better understood, and so that the present contribution to the art can be more fully appreciated. Additional features of the invention will be described hereinafter, which form the subject of the claims of the invention. It should be appreciated by those skilled in the art that the conception, method, and apparatus disclosed might be readily utilized as a basis for modifying or designing other electrolysis systems for carrying out the same purposes of the present invention. It should also be realized by those skilled in the art that such equivalent structures do not depart from the spirit and scope of the invention as set forth in the appended claims.

### DESCRIPTION OF THE FIGURES

Other objects, features, and advantages of the present invention will be apparent from the written description and the drawings in which:

FIG. 1 is a schematic diagram of the present invention.

FIG. 2 is a schematic diagram showing in more detail the operation of the electrolysis tank of the present invention.

FIG. 3 is a schematic diagram showing in more detail the operation of the water distillation system of the present invention.

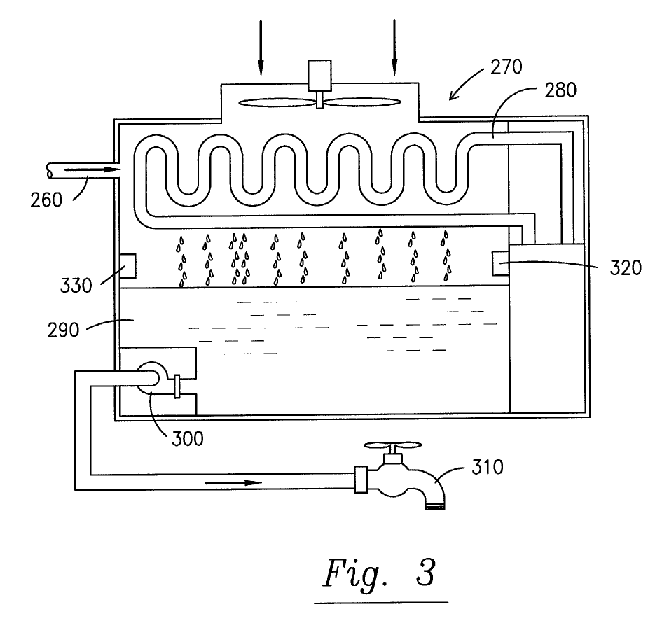

FIG. 4 is a schematic diagram showing in more detail the operation of the gas burning AC/DC power generator of the present invention.

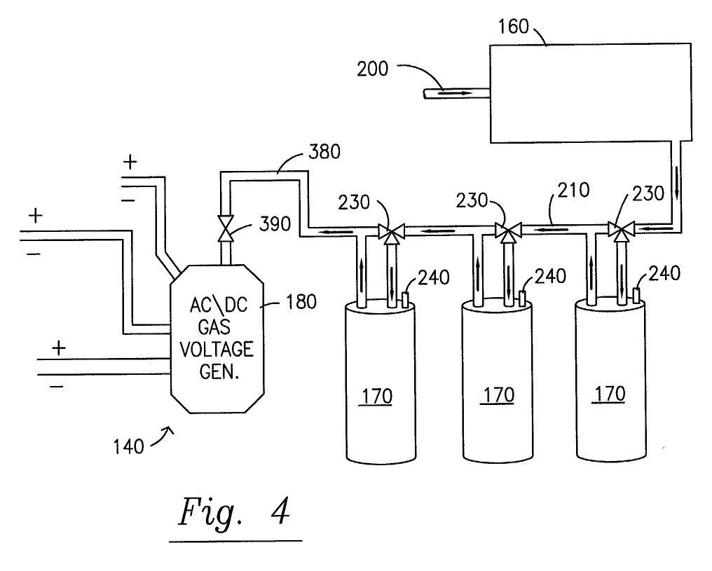

FIG. 5 is a schematic diagram showing in more detail the operation of the fuel gas storage tank of the present invention.

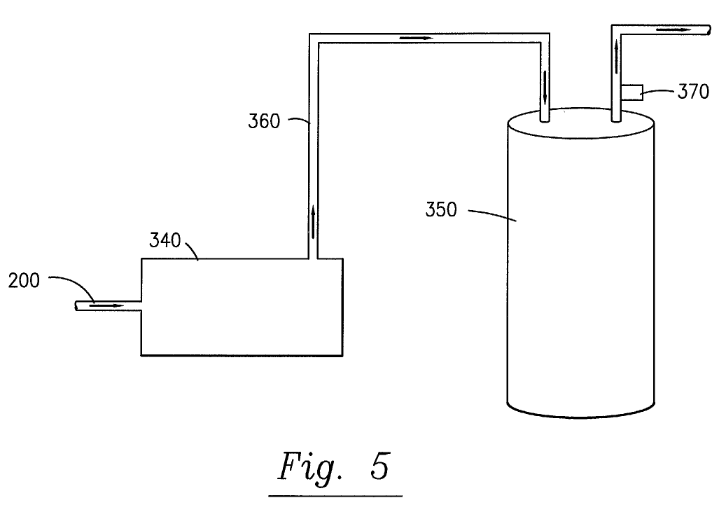

### DETAILED DESCRIPTION OF THE INVENTION

The present inventor surprisingly discovered that fuel gas can be produced by the electrolysis of graphite under water, and that this process does not require high-energy consumption or produce contaminants.

The graphite is pure carbon, and in order to transform the carbon into the gaseous form, the energy needed is minimal compared with the energy needed if a carbonaceous product (long chain carbon) is used. Thus, a great amount of savings could be achieved.

Another advantage of the present invention is that because graphite, pure carbon, is used, the present invention avoids the presence of contaminants such as nitrogen and sulfur that produce contaminants such as oxides of nitrogen and sulfur common in the gasification of carbonaceous products.

By placing the apparatus near or inside the building, the energy loss will be reduced along with the manufacture cost.

All of the components can be mounted to a mobile enclosure 10 such as a trailer or case. The size of the mobile enclosure will depend on the building requirements. The mobile enclosure 10 has a bottom wall 20 and sidewalls 30, a top wall 40 and wheels (not shown). When the mobile enclosure is a trailer, it also includes a hitch (not shown) to permit towing of the trailer behind a vehicle such as a pickup truck.

The operation of the method and apparatus will now be described.

Electrolysis Tank

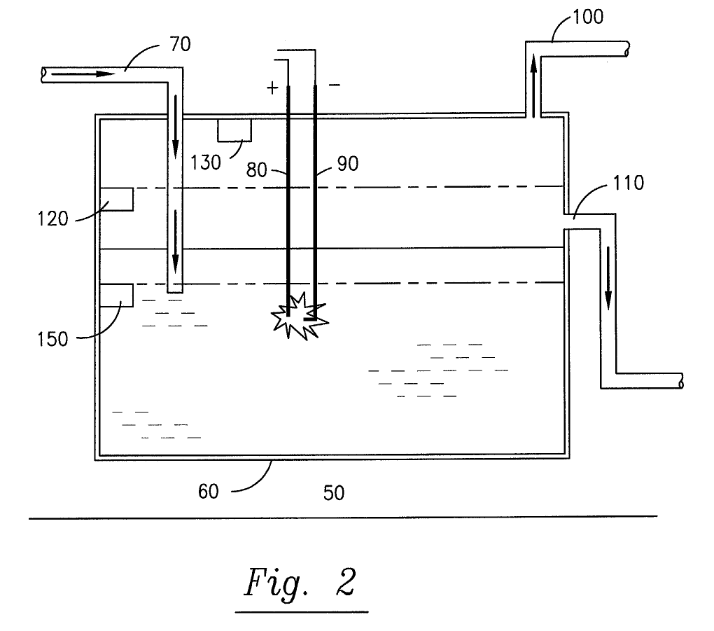

FIG. 2 shows the electrolysis tank. The electrolysis tank 50 includes a reservoir 60, water input 70, a cathode 80, an anode 90, a fuel gas output 100, and a water vapor output 110.

The invention uses graphite bars between 18 inches to 6 feet long, and 1/8 inch to 3 inches in diameter, such as the ones supplied by SGL Carbon Group.

The cathode and anode are separated at a distance between 1/132 to 1/8 of an inch, preferably 1/16 of an inch.

The electrolysis tank 50 will take graphite and transform it into a fuel gas underwater. A direct voltage potential of between 50 and 500 volts, preferably 80 to 300 volts, most preferably 240 volts, is applied constantly to the graphite in order to produce a spark that causes the graphite to transform into gas form. The amount of voltage applied to the apparatus depends on the size of the graphite bars.

The electrolysis process is conducted underwater; in this case tap water, and the reaction tank is made up of non-corrosive materials such as stainless steel.

The tap water used in the process of this invention is not subject to any unusual requirement.

The spark produced during the electrolysis generates enough heat to boil the water inside the electrolysis tank and also dissociate the water into its chemical elements, hydrogen & oxygen.

These two gases will rise to the top of the tank, and they will merge with the gas that was generated by the graphite. The combination of these three gases generates the desired fuel gas.

This fuel gas can replace acetylene, and natural and propane gas because it does not leave any residue behind inside the tank as is customary by acetylene and propane gases.

The electrolysis tank 50 will also include an automatic rod feeder (not shown). The automatic rod feeder, which holds and dispenses the carbon rods, is conveniently made of metal, plastic, or ceramic. The automatic feeder may accommodate any convenient number of rods, conveniently loaded upright side-by-side on an inside surface slanting down to an exit directly above the desired electrode-bridging location. The feeder will allow the system to run for a long period of time without human intervention.

The tank will also have a conventional water level safety switch 120 to protect the system from overflow.

In addition, the tank will have a conventional safety release valve 130 to protect the system from exploding due to failure of the suction pumps that extract the fuel gas from the electrolysis tank and feed it to the power generating section 140. The system also contains an emergency shut off switch 150.

The Power Generating Stage

A portion of the fuel gas generated by the electrolysis tank will be pumped via an air compressor 160 into storage tanks 170 that will be used to feed a gas-burning generator 180. The fuel gas is pumped by a fuel gas pump 190 through conduit 200 into the air compressor 160. The air compressor 160 pumps the fuel gas into the storage tanks 170 through conduit 210.

The gas-burning generator 180 is a conventional, commercially available unit. A typical unit for a one-family house could consist of a four to twelve kilowatt gas-burning generator. The output of the generator is routed to the building electrical energy distribution system, the main junction box of an existing building, for example. The building's internal distribution system, the wires and outlets in the typical house, supplies power to various applicances, lights, and the like.

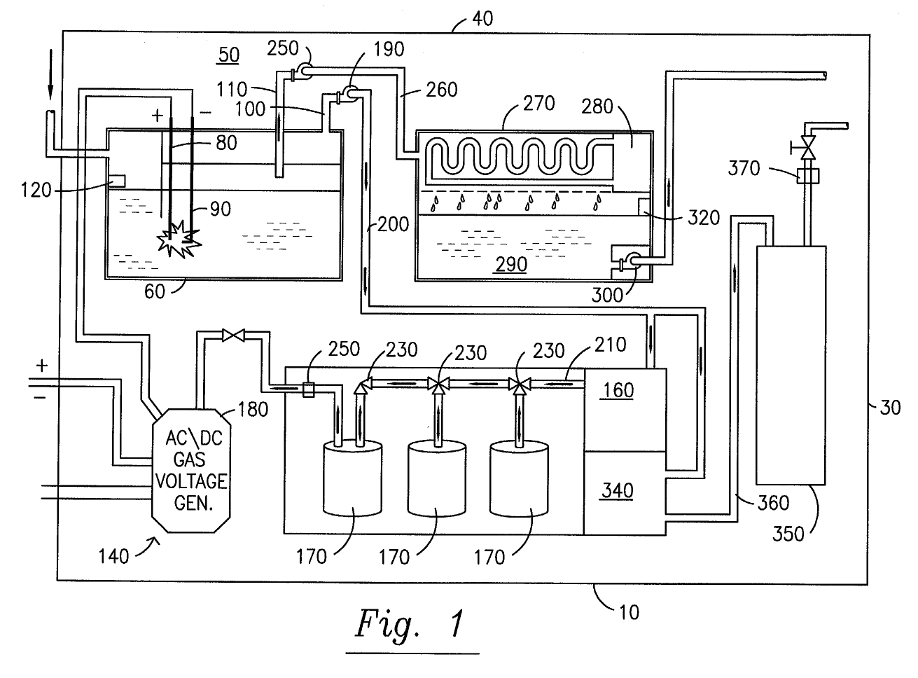

The mechanical aspects of the new electrical power generating apparatus of the present invention on FIG. 1 shows only a simplified physical arrangement of mechanical elements of the invention within an mobile enclosure 10. However, the system includes relatively more compact electronic circuitry including various sensors and controls, which may also be contained within enclosure 10. Therefore, it should be observed that enclosure 10 may also house certain elements of such circuitry except those which are necessarily located outside the enclosure for interconnection or use in association with pre-existing electrical wiring interconnecting a AC utility service with household or similar electric load, for which the new system is intended to provide AC power.

The air compressor 160 is a conventional, commercially available unit.

The generator 180 will produce all the electrical (120VAC, 240VAC & up to 400VDC) power needed to maintain the system operating all the time, as well as to supply the power requirements of the building. The generator has a minimum output of 4,000 watts.

The fuel gas produced by the electrolysis is accumulated in at least one storage tank, but it should be expressly understood that a plurality of storage tanks can be utilized in the process of the present invention; the number of storage tanks used and the size of these tanks will depend in part on the quantity of fuel gas to be stored do to the need of the customer being serve.

In those cases where more than one storage tank is utilized, it is desirable to introduce the fuel gas into the storage tanks, one tank at a time, until all of the tanks are charged with the appropriate amount of fuel gas. Among the techniques by which this can be achieved is to provide line 210 as the source of fuel gas for each storage tank and each storage tank with a valve 230 to control the flow of fuel gas from line 210. Each tank is also providing with escape release valve 240 to control the tank pressure. The line 210 is provided with a pressure sensor relay 250 to control the line pressure.

The fuel gas passes to the gas-burning generator 180 through conduit 380. The conduit includes an intake gas control valve 390.

Water Purification Section

As was mentioned above, the electrolysis processs generates a spark that will produce enough heat to boil the water inside the electrolysis tank. The steam will be collected in a separate unit within the apparatus and will be processed through a distiller in order to generate pure water.

Once the steam is pumped in the distiller, the unit will condense the steam in the primary chamber of the distiller. The distiller uses a chemical coolant coil 280 to cool off the steam pumped into the distiller 270. When the steam is cooled, it will turn into pure water that will be collected in the second section of the distiller that will be a holding tank 290.

From the holding tank, the pure water will be pumped out of the apparatus by means of an internal water pump 300 that will supply an outside faucet 310 to be used by the user.

The holding tank will have a safety water level switch 320 that when the water level of the tank has reached its maximum height, will cut off the cooling system, and the steam that is pumped into the water distiller will escape via an emergency steam release valve 330.

All systems require pipes, valves, pumps, and control circuits to control the operation of the system and obtain the desired output with a maximum of efficiency. The dual-purpose system arrangement, which existed prior to the invention to be described in detail, is such that the amount of pure water produced was directly dependent upon the electrical power produced.

Fuel Gas Storage Section

Another portion of the fuel gas generated by the electrolysis tank will be pumped via an air compressor 340 into storage tank 350 that will be used to generate the building needs for fuel gas to be used for heating & air conditioning systems, stoves, water heaters, BBQs, etc.

The fuel gas is pumped by a gas pump 190 through conduit 200 into the air compressor 340. The air compressor 340 pumps the fuel gas into the storage tank 350 through conduit 360.

The storage tank 350 will be an 80 to 100 gallon tank that will hold the fuel gas generated by the present invention at 2,500 PSI. The tank 350 includes a pressure sensor relay 370.

From the foregoing detailed description of the disclosure, it is evident that the instant invention is novel and is a contribution of great significance to the art to the production of energy, pure water, and fuel gas to fullfill the requirements of a building. All in all, it is submitted that the present invention provides a new and useful method and apparatus for the making of fuel gas from carbon efficiently in order to make available clean and abundant energy on which our country depends.

This method should not be understood as violating any accepted scientific principle, but only as applying science to economic advantage, as facilitated by the negative voltage coefficient of electric arcs.

It will be seen that this system gives a very high overall efficiency compared with a heating and power system run wholly from an external main supply. The increase in efficiency provides conservation of energy and savings in the overall direct costs of light, power, and heating and cooling for a building. The extra capital costs for installing the apparatus versus the costs of conventional systems are reduced to the minimum.

Appropriate standard sizes can be developed for buildings ranging from commercial and industrial to single-family residential.

What I claim is:

1. An apparatus for supplying a building simultaneously with AC/DC electrical power, pure water and fuel gas, the apparatus comprising in combination:
an electrolysis tank adapted for converting graphite into a fuel gas by an electrolysis process under water, wherein the electrolysis process further produces a steam;
a water distiller adapted to receive the steam produced by the electrolysis process and generate pure water;
a storage tank adapted to receive a first portion of the fuel gas and dispense the fuel gas according to the the building requirements; and
a gas burning generator adapted to receive a second portion of the fuel gas and generate AC/DC electrical power;
wherein the apparatus has a minimum output of 4,000 watts.

2. An apparatus according to claim 1, wherein further comprising a mobile platform, wherein the apparatus is mounted on the mobile platform.

3. An apparatus according to claim 1, wherein the electrolysis tank includes a reservoir, a top, a bottom, a cathode, and an anode.

4. An apparatus according to claim 3, wherein the distance between the cathode and the anode is from about 1/132 to 1/8 of an inch.

5. An apparatus according to claim 3, wherein the distance between the cathode and the anode is 1/16 of an inch.

6. An apparatus according to claim 3, wherein the reservoir is adapted to received the water and the graphite and further including means for constantly applying a direct voltage potential inside the reservoir.

7. An apparatus according to claim 6, wherein the direct voltage potential is from about 50 to 500 volts.

8. An apparatus according to claim 7, wherein the direct voltage potential is from about 80 to 300 volts.

9. An apparatus according to claim 7, wherein the direct voltage potential is about 240 volts.

10. A portable system to provide electrical power to a building, the system comprising in combination:
(a) an electrolysis tank adapted for converting graphite rods into a gas by an electrolysis process underwater;
(b) a line connected to the electrolysis tank to transport the gas;
(c) an air compressor connected to the line to receive the gas; and
(d) at least one holding tank connected to the air compressor, at least one holding tank adapted to recieved the gas from the air compressor and feed a gas-burning generator;
wherein the apparatus has a minimum output of 4,000 watts.

11. A portable system according to claim 10, wherein the electrolysis tank includes a reservoir, a top, a bottom, a cathode, and an anode.

12. A portable system according to claim 11, wherein the distance between the cathode and the anode is from about 1/132 to 1/8 of an inch.

13. A portable system according to claim 11, wherein the reservoir is adapted to received the water and the graphite and further including means for constantly applying a direct voltage potential inside the reservoir.

14. A portable system according to claim 13, wherein the direct voltage potential is from about 50 to 500 volts.

15. A portable system to provide pure water to a building, the system comprising in combination:
(a) an electrolysis tank adapted for converting graphite rods into a gas by an electrolysis process underwater, wherein the electrolysis process further produced a steam;
(b) a line connected to the electrolysis tank to transport the steam;
(c) a water distiller connected to the line and adapted to receive the steam from the elctrolysis tank, wherein the water distiller is adapted to produce pure water; and
(d) a line connected to the water distiller to transport the pure water into the building.

16. A portable system to provide fuel gas to a building, the system comprising in combination:
(a) an electrolysis tank adapted for converting graphite rods into gas by an electrolysis process underwater;
(b) a line connected to the electrolysis tank to transport the gas;
(c) a holding tank connected to the line and adapted to receive the gas from the electrolysis tank; and
(d) a line connected to the holding tank to transport the gas into the building;
wherein the gas is fuel gas.

17. A portable system according to claim 12, wherein the fuel gas is used for at least one of a heating system, a stove, an oven, a water heater, and a grill apparatus.
